(19) United States
(12) Patent Application Publication
(10) Pub. No.: US 2018/0078342 A1
(43) Pub. Date: Mar. 22, 2018

(54) Dental Appliance For Use as an Aligner and as a Tool to Reduce Temporomandibular Dysfunction

(71) Applicant: William Graham Gardner, Richmond, VA (US)

(72) Inventor: William Graham Gardner, Richmond, VA (US)

(21) Appl. No.: 15/709,501

(22) Filed: Sep. 20, 2017

Related U.S. Application Data
(60) Provisional application No. 62/397,410, filed on Sep. 21, 2016.

(51) Int. Cl. A61C 7/36; A61C 13/00; A61C 7/08

(52) U.S. Cl. CPC A61C 7/36; A61C 7/08; A61C 13/0003

(57) ABSTRACT

A dental appliance or set of appliances that incorporate projections, and optionally bite ramps, that can be used to have both an aligning function and a treatment of temporomandibular dysfunction. The projections may extend upwardly from the occlusal surface of the mandibular polymeric shell appliance. The bite ramps may be incorporated into the back of the maxillary polymeric shell of the appliance.

This application claims the benefit of U.S. Provisional Application No. 62/397,410, filed Sep. 21, 2016, entitled “Invisalign TMD”, which is incorporated by reference herein in its entirety.

The present invention is directed to a dental appliance that serves as both a teeth aligner and simultaneously as a tool for reducing temporomandibular dysfunction. The polymeric shell of the present appliance has both a teeth-receiving cavity on one side and projections and bite ramps on the opposite side that serve the alignment and TMD reduction and/or management purposes respectively.

### BACKGROUND

The field of orthodontics has creatively pursued the goal of correctly positioning teeth for many years. The goal of course is to achieve the best possible teeth function and aesthetics for a patient. One traditional and still popular method of orthodontics is the mounting of braces on teeth that are then urged to proper position with the use of wires and rubber bands. Over time, under the skilled guidance of an orthodontist, these braces are adjusted and the patient's teeth are moved to a final position of improved function and aesthetics.

A more recent method for positioning teeth uses multiple sets of individual appliances. The appliances, in the form of polymeric shells that cover and receive the teeth, are engineered to be used in a specific sequence to move the teeth to predetermined intermediate positions through the specifically ordered use of the engineered polymeric shells. The ultimate goal is a final positioning of the teeth in a desired way for improved function and aesthetics. These polymeric shells are commonly referred to as plastic aligners in reference to their purpose to align the patient's teeth.

During treatment of their patients, orthodontists can observe or hear about possible problems that a patient has with respect to their teeth and their proper bite functionality. One widely observed problem in patients is temporomandibular dysfunction (“TMD”). Very generally stated, TMD is the improper function and resulting pain in the muscles that move the jaw and the temporomandibular joints that connect the mandible to the skull. The resulting pain can be relatively temporary, but in some cases it can last weeks and months. There is no known single cause of TMD. Rather, there are multiple factors that have been observed that contribute to TMD including trauma, physiology, genetics, stress and arthritis. The most common methodology for managing the symptoms of TMD is the use of an occlusal splint. The most common way of making this splint is to fabricate an acrylic splint so that it covers all of the teeth evenly, but allows the teeth to separate when the mandible moves side to side contacting only the canines (canine guidance) and when the mandible moves forward contacting only the anterior teeth (anterior disclusion). Another common splint only allows the anterior teeth to touch and opens the bite so that the back teeth are unable to touch.

The problem with splints for treating TMD symptoms is that the splints act as retainers. They prevent the patient's teeth from moving or repositioning during orthodontic procedures. Sometimes, an orthodontist will create a TMD splint for one arch (mandibular OR maxillary) as the opposite arch is being aligned. When the first arch is repositioned as required by the orthodontist, then a TMD splint is made for the corrected arch and the second arch is then aligned. Sometimes, orthodontists attempt to treat the repositioning of the teeth very quickly and then move to a TMD splint post treatment. The patient then just has to live with the discomfort and other symptoms during orthodontic treatment. The challenges of TMD may even lead some patients to forego orthodontic treatment altogether.

### SUMMARY

Accordingly, it is an object of the present invention to overcome the drawbacks of treating both TMD and orthodontic repositioning of the teeth. In one example, the polymeric shells that can be used to reposition teeth are modified to also function as a splint for treatment of TMD. This dual functionality allows another option to orthodontists who are both repositioning teeth and treating the symptoms of TMD.

In one example, a dental appliance for concurrent use as a teeth aligner and a tool for reducing temporomandibular dysfunction comprises a pair of polymeric shells having a teeth-receiving cavity that defines a first side thereof, wherein the pair of polymeric shells are comprised of a thin layer of elastomeric polymer adapted to fit over the maxillary and mandibular teeth of a patient respectively. The polymeric shells have an anterior portion that corresponds to the anterior maxillary or mandibular teeth that are adapted to be received therein. There is a projection on the mandibular polymeric shell, wherein the projection is an intentional plastic protuberance extending upwardly from the mandibular polymeric shell proximate an occlusal surface of where the anterior mandibular teeth would be received in the cavity. There is also a bite ramp on the maxillary polymeric shell, wherein the bite ramp is an intentional plastic protuberance on the opposite side of the maxillary polymeric shell from the cavity and proximate the location where the back of the anterior maxillary teeth would be received in the cavity. The projection and the bite ramp are located so that they will contact each other when a patient is wearing the appliance and they bite their teeth. The dental appliance may further comprise a plurality of projections from the mandibular plastic shell. The dental appliance may further comprise a plurality of bite ramps on the maxillary polymeric shell. The projection may be molded into the polymeric shell or alternatively, the projection may be affixed to the outside of the polymeric shell. The plurality of projections may comprise four projections that are located proximate the top of the mandibular polymeric shell where the cavity is adapted to receive the mandibular incisor teeth of a patient. The plurality of bite ramps may comprise four bite ramps that are located proximate the back of the maxillary polymeric shell where the cavity is adapted to receive the maxillary incisor teeth of a patient. The appliance may further comprise a plurality of bite ramps on the maxillary polymeric shell, wherein the plurality of bite ramps comprises four bite ramps that are located proximate the back of the maxillary polymeric shell where the cavity is adapted to receive the maxillary incisor teeth of a patient. The projection may be positioned as a single ridge along the top of the mandibular polymeric shell on a second side of the polymeric shell opposite the first side of the polymeric shell.

In a second example, a dental appliance for concurrent use as a teeth aligner and a tool for reducing temporomandibular dysfunction comprises a pair of polymeric shells having a teeth-receiving cavity that makes up a first side thereof, wherein the pair of polymeric shells are comprised of a thin layer of elastomeric polymer adapted to fit over the maxillary and mandibular teeth of a patient respectively. The polymeric shells have an anterior portion that corresponds to the anterior maxillary or mandibular teeth that are adapted to be received therein. A projection is positioned on the mandibular polymeric shell, wherein the projection is an intentional plastic protuberance on the opposite side of the mandibular polymeric shell from the cavity and proximate an occlusal surface where the top of the anterior mandibular teeth would be received in the cavity.

In a further example, a set of dental appliances for concurrent use as a teeth aligner and a tool for reducing temporomandibular dysfunction comprises a first pair of polymeric shells having a teeth-receiving cavity that makes up a first side thereof, wherein the pair of polymeric shells are comprised of a thin layer of elastomeric polymer adapted to fit over the maxillary and mandibular teeth of a patient respectively. The polymeric shells further have an anterior portion that corresponds to the anterior maxillary or mandibular teeth that are adapted to be received therein. A projection is positioned on the mandibular polymeric shell, wherein the projection is an intentional plastic protuberance on the opposite side of the mandibular polymeric shell from the cavity and proximate an occlusal surface where the top of the anterior mandibular teeth would be received in the cavity. A bite ramp is positioned on the maxillary polymeric shell, wherein the bite ramp is an intentional plastic protuberance on the opposite side of the maxillary polymeric shell from the cavity and proximate the location where the back of the anterior maxillary teeth would be received in the cavity. The projection and the bite ramp are located so that they will contact each other when a patient is wearing the appliance and they bite their teeth. The kit further comprises a second pair of polymeric shells having a teeth-receiving cavity that makes up a first side thereof, wherein the polymeric shells have an anterior portion that corresponds to the anterior maxillary or mandibular teeth that are adapted to be received therein, and wherein the second pair of polymeric shells do not comprise projections or bite ramps.

### BRIEF DESCRIPTION OF THE DRAWINGS

FIG. 1 is an exploded perspective view of a mandibular arch and a conventional polymeric sheet dental appliance.

FIG. 2A is a rear perspective view of the back of the maxillary arch of teeth.

FIG. 2B is a rear perspective view of the back of the maxillary arch of teeth with a polymeric sheet appliance mounted thereon.

FIG. 2C is a rear perspective view of the back of the maxillary arch of teeth with a polymeric sheet appliance mounted thereon and a bite ramp extending outwardly from the back of the polymeric sheet.

FIG. 2D is a rear perspective view of the back of the maxillary arch of teeth with a polymeric sheet appliance mounted thereon and a bite ridge extending outwardly from the back of the polymeric sheet.

FIG. 3A is a side, cross-sectional view of a maxillary incisor tooth.

FIG. 3B is a side, cross-sectional view of a maxillary incisor tooth with a polymeric sheet wrapped around the tooth.

FIG. 3C is a side, cross-sectional view of a maxillary incisor tooth with a polymeric sheet wrapped around the tooth and a bite ramp out the back side of the polymeric sheet.

FIG. 3D is a side, cross-sectional view of a maxillary incisor tooth with a polymeric sheet wrapped around the tooth and an alternative bite ramp out the back side of the polymeric sheet.

FIG. 4A is a front view of the teeth of a mandibular arch.

FIG. 4B is a front view of a polymeric sheet appliance mounted on and around the teeth of a mandibular arch.

FIG. 4C is a front view of a polymeric sheet appliance mounted on and around the teeth of a mandibular arch with the appliance having protuberances extending upwardly from the appliance.

FIG. 4D is a front view of a polymeric sheet appliance mounted on and around the teeth of a mandibular arch with the appliance having an alternative protuberance extending upwardly from the appliance.

FIG. 5A is a side, cross-sectional view of a mandibular incisor tooth.

FIG. 5B is a side, cross-sectional view of a mandibular incisor tooth with a polymeric sheet wrapped around the tooth.

FIG. 5C is a side, cross-sectional view of a mandibular incisor tooth with a polymeric sheet wrapped around the tooth and a protuberance extending upwardly from the incisal edge of the top of the appliance.

FIG. 5D is a side, cross-sectional view of a mandibular incisor tooth with a polymeric sheet wrapped around the tooth and an alternative protuberance extending upwardly from the incisal edge of the top of the appliance.

FIG. 6A is a side, cross-sectional view of a maxillary incisor tooth disposed above a mandibular incisor tooth.

FIG. 6B is a side, cross-sectional view of a maxillary incisor tooth disposed above a mandibular incisor tooth with each tooth covered by a polymeric shell appliance, and the mandibular incisor having a bite ramp extending outwardly in the back of the maxillary appliance and a protuberance extending upwardly from the top of the mandibular appliance, with the teeth in an open position.

FIG. 6C is a side, cross-sectional view of a maxillary incisor tooth disposed above a mandibular incisor tooth with each tooth covered by a polymeric shell appliance, and the mandibular incisor having a bite ramp extending outwardly in the back of the maxillary appliance and a protuberance extending upwardly from the top of the mandibular appliance, with the teeth in a closed position.

### DETAILED DESCRIPTION

A dental appliance is described herein that includes a polymeric shell that may fit over either or both of the teeth of a patient's mandibular or maxillary arch. This appliance is functionally both a teeth aligner and a TMD treatment splint. By incorporating projections onto a mandibular appliance, and optionally bite ramps onto a maxillary appliance, the appliance or set of appliances herein can serve both functional purposes.

An adjustment appliance may be worn by a patient to obtain an incremental positioning of individual teeth in the patient's jaw. The dental appliance itself is a polymeric shell having a teeth-receiving cavity that defines one side thereof. A series of sets of these polymeric shells (a set being a pair of polymeric shells—one each for the mandibular and maxillary arch/teeth) is engineered to have a geometry that corresponds to intermediate or final tooth arrangements intended for each appliance. As is known, the intermediate and final teeth geometry is incrementally differentiated to move the patient's teeth to the final, desired positioning when worn in order by the patient over time. In some cases, dental attachments may also be temporarily fixed onto a side of one or more of a patient's teeth to help with the repositioning function of the appliance.

The polymeric shells can fit over all teeth present in the mandibular or maxillary teeth/arches respectively. In some specific, infrequent circumstances, the polymeric shells may not fit over all of the teeth. In one example, a patient's tooth may just be coming in; therefore, there is no need or desire to fit over the fast-moving tooth that is arriving. Sometimes or often, only certain ones of the teeth will be repositioned while others of the teeth serve as a base or anchor region for holding each appliance in place as the appliance applies a resilient repositioning force against the teeth that are targeted for movement. Over a series of sets of the appliances, many of the teeth can be engineered to be the teeth that are moving or they can be used as the anchor for other teeth to be moved.

The polymeric sheet of the appliance is conventionally a generally uniformly thin sheet of polymeric material, such as Tru-Tain 0.03 in, thermal forming dental material, available from Tru-Tain Plastics. Different additional polymer formulations may be and are used that have the same or similar desired resiliency and durability functionality. Conventionally, no wires or other components are required to hold the appliance in place over a patient's teeth, but wires or other components may optionally be used for retaining purposes. And of course other polymeric materials may also optionally be used. It is desirable that the polymeric shell be made of thin plastic material so that the plastic does not operate as an uncomfortable presence in the mouth of the patient. In one example, the plastic shell sheet may have a thickness of from about 0.005 to 0.1 inches, or alternatively about 0.01 to 0.08 inches, or still further alternatively about 0.03 to 0.05 inches. Inevitably, there will be some modest variance in thickness of the shell in the final appliance that is molded to fit a person's teeth. With a thin shell like this, unintended, negative side effects of a thick plastic shell may be minimized or avoided.

As noted herein, the appliances described herein serve the second purpose of treating TMD. In order to accomplish this functionality, projections are added to the front or anterior portions of a mandibular appliance. The added projections function similar to splints that are currently used to treat TMD. In addition to the this thin layer of polymeric material that forms a conventional repositioning appliance, additional plastic material is added to form an intentional plastic protuberance that extends upwardly from the mandibular appliance. To place the protuberance in proper orientation, the protuberance extends upwardly from the top of the mandibular appliance on the opposite side of the mandibular shell opposite the side of the cavity that receives the teeth and also proximate the top or occlusal or incisal surface of the teeth received in the shell.

The size of the projections is defined in terms of height, specifically additional height of the appliance over a regular, unmodified appliance polymeric shell. The added height of the projection may be from about 0.2 mm to 2 cm, or alternatively about 0.5 mm to about 5 mm, or still further alternatively about 1 to 2 mm. The size height of the projection is selected by the orthodontic professional by factoring multiple considerations including the shape of a patient's mouth, the overage of the teeth in a patient's bite, the seriousness of the apparent TMD and other factors. In addition to the height, the width and depth dimensions of the projection may also vary. The projection will be fairly narrow in depth to correspond qualitatively to the relatively narrow width of the top of the patient's teeth when determining the projection depth of anterior teeth such as the incisors or canines. A projection that may be configure to extend outwardly from a patient's teeth further back in the posterior section of the mandibular arch may be larger in depth to correspond to the size of the teeth being enclosed in that portion of the polymeric shell. The depth may be from about 1 mm to 5 mm. Likewise, the width of the projection may vary. The width may correspond to the width of the patient teeth. The width may range from about 1 mm to about 8 mm. Finally, these dimensions of the projection may be referred to in the context of the individual teeth where they would project upwardly from (on the opposite side of) the polymeric shell cavity that receives that tooth. Alternatively, the projection may form a ridge or ridges that span more than a single tooth. In one example, the projection might be a ridge that spans two or all four of the incisal teeth only or even the entire arch. In another example, a ridge might span the incisors and canine teeth of a patient.

The shape of this projection on the mandibular appliance may vary. From a top view, the shape may be rectangular, oval, square, round, trapezoidal or other shapes. The shape may be symmetrical or asymmetrical. It is expected that the shape with interact with the engineered shape of the bite ramps described herein or to otherwise interact with the structure of the maxillary arch of a patient.

In some examples, the mandibular appliance may only have two projections that extend upwardly from the polymeric shell above the two middle incisors. Alternatively, the projections may be configured above all four incisors, above all four incisors and the canines, or above any one or more teeth as determined appropriate by the dental professional.

The actual composition of the projection may be any durable plastic material. It may be the same polymer as the composition of the entire aligner appliance as noted earlier. It may be harder or softer to achieve a therapeutic purpose as determined by the dental professional.

The projections may be configured onto the mandibular polymeric shell in any fashion known to those of skill in this fabrication art. Traditionally, stated very simplistically, a ceramic-type mold is made of a patient's teeth based on a physical mold process or based on a digital scan of a patient's teeth. The thin polymeric sheet is then vacuum-formed around that mold to form the dental appliance that goes in the patient's mouth. The projections described herein may be added to the polymeric shell in multiple ways. In one inside method, the predetermined, intentional size and shape of the projection is formed of a plastic material, and that individual formed piece of material is placed on the mold onto the incisor occlusal surface (or over whatever other tooth the projection is engineered to extend from). The thin polymeric shell is then vacuum formed over the enhanced mold with the resulting appliance having the desired projection. Other, outside methods may also be used where the predetermined, intentional projection material may be attached onto the outside of the thin polymeric shell material after it is formed over the mold. A still further method of formation would be to use the digital scan of a patient's teeth to then engineer the intended shape of the projection into the digital file. An appliance could then be formed using a 3-D printer or similar technology to create the resulting appliance having the desired projections.

Also, projections could be added to the maxillary appliance in the same fashion that they were added to the mandibular appliance. In other words, in this alternative, projections may be added to a maxillary appliance to extend downwardly from the occlusal surface of the polymeric shell that covers the maxillary teeth. These maxillary projections would come into contact with the top surface of the mandibular polymeric shell, or alternatively, could be engineered to come into contact with mandibular bite ramps that would be functionally positioned in a strategic manner as the maxillary bite ramps described in the following. It is expected that the maxillary projections would be relatively similar in size to the mandibular projections described herein, and they would be formed in or on the appliances the same way.

In addition to the projections on a mandibular appliance, it is expected that bite ramps may also be desired on the back of a maxillary appliance. The bite ramps described herein are engineered to come into contact with the mandibular appliance projections in the ordinary closing of a mouth by a patient. While the projections may be sufficient on their own to reduce TMD symptoms, the bite ramps may further improve that functionality. A bite ramp is an intentional plastic extension on the maxillary appliance positioned on the back of the outside of that polymeric shell relatively on the opposite side of the shell from the back of a maxillary tooth. In one expected example, the bite ramp would be on the back of the appliance proximate the anterior teeth of the maxillary arch including, for instance, the incisors and canines of a patient. The bite ramp may have a downwardly-facing flat surface that serves as the point of contact for the top of a mandibular appliance projection. The bite ramp, therefore, may be used to help modify the bite of the patient to treat TMD symptoms.

The size of a bite ramp is referenced in terms of the backward extension or width from the outside of the maxillary polymeric shell from the teeth cavity. The overage of a patient's bite, or a lack thereof, will vary widely between patients. Therefore, the size of backward extension will similarly vary. This backward width size may range from about 1 mm to about 1 cm, or alternatively, about 3 mm to about 8 mm, or still further about 4 mm to 5 mm.

The bottom view shape of a bite ramp may be any shape selected by the dental professional including, but not limited to, rectangular, square, oval, circular, semicircular, trapezoidal, symmetric, and asymmetric. The bottom bite ramp surface may be flat or ridged or otherwise textured. From a side perspective, the bite ramp is generally triangular, with one side of the triangle corresponding to the slope of the back of the proximate tooth to be received in the cavity of the appliance. Another side of the triangle forms the backward width of the bite ramp extension.

The bite ramp is expected to be formed of the same or similar, durable polymer material as the polymeric appliance generally. The bite ramp may be attached or formed into the maxillary polymeric shell in the similar methodologies as with the projections being added to the mandibular polymeric shell.

As is also the case with the projections, the bite ramps may be incorporated on a per tooth basis, or alternatively, a bite ramp shelf may be formed to range across multiple teeth. The bite ramps will be formed behind one or both of the middle incisors, all four incisors, all anterior teeth including the incisors and. canines. It is hypothetically possible that a bite ramp may be incorporated behind the polymeric shell formed around multiple, or even all of the maxillary teeth.

At present, polymeric aligner shells are intended to be worn essentially all day be a patient but for meals and tooth cleaning or other allowed breaks from use. There is a single set of all-24 hour day appliances. Because the projections described herein might not be cosmetically pleasing for a user, and because the TMD symptoms most often occur in the nights, it is intended that the appliances described herein would be a kit of two sets of aligner appliances. There would be “daytime” appliances that are formed solely from the thin polymeric sheet. This is cosmetically pleasing and acceptable. However, the second set of “nighttime” appliances would incorporate the projections and bite ramps when the cosmetic aspects of the aligner appliances are not needed or are less desired. The patient would receive the aligner and cosmetic benefits during daytime use, and aligner and TMD benefits during use of the second, nighttime set. A patient user might be provided visual assistance in distinguishing the respective pair of appliances. Different aligner cases or aligner color codes could be used to assist the user in selecting the correct aligners for use.

The figures illustrate examples of the dual function dental appliances as described herein.

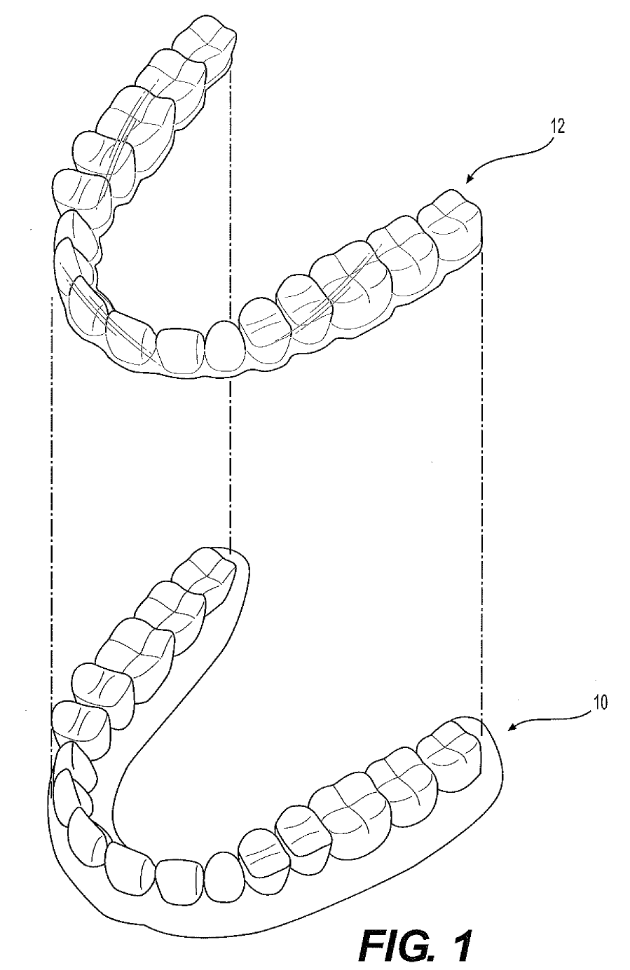

FIG. 1 shows typical mandibular arch teeth 10 and a polymeric shell 12 formed of a thin layer of an elastomeric polymer. The polymeric shell 12 is specifically formed and shaped to fit over the teeth 10 of the mandibular arch. Visually, the shape of the polymeric shell 12 substantially mirrors the shape of these mandibular arch teeth 12. The polymeric sheet 12 is a dental appliance that generally might resemble a retainer or aligner.

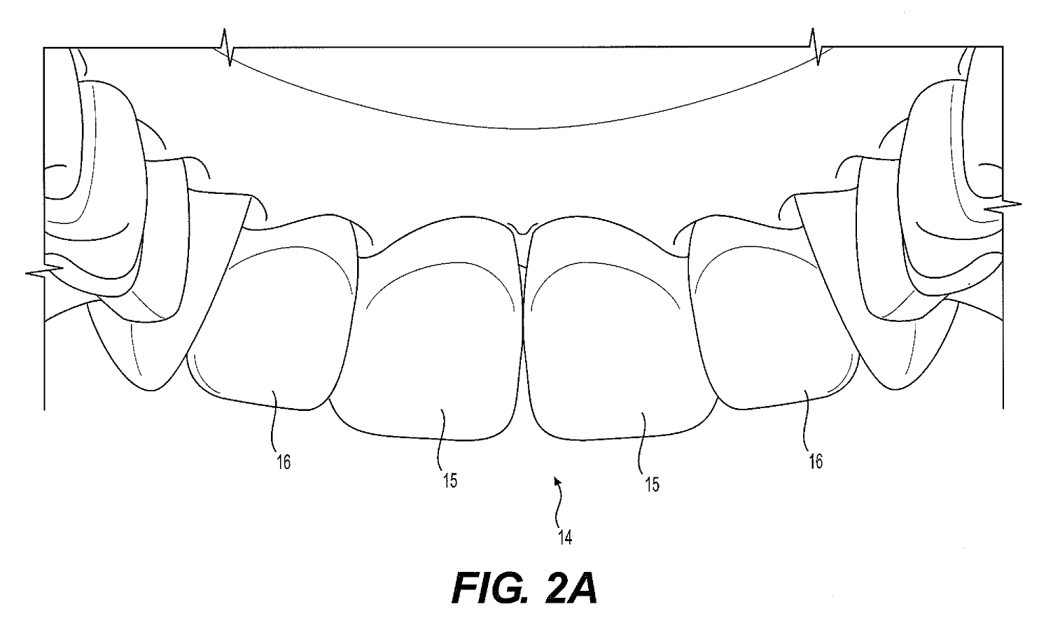

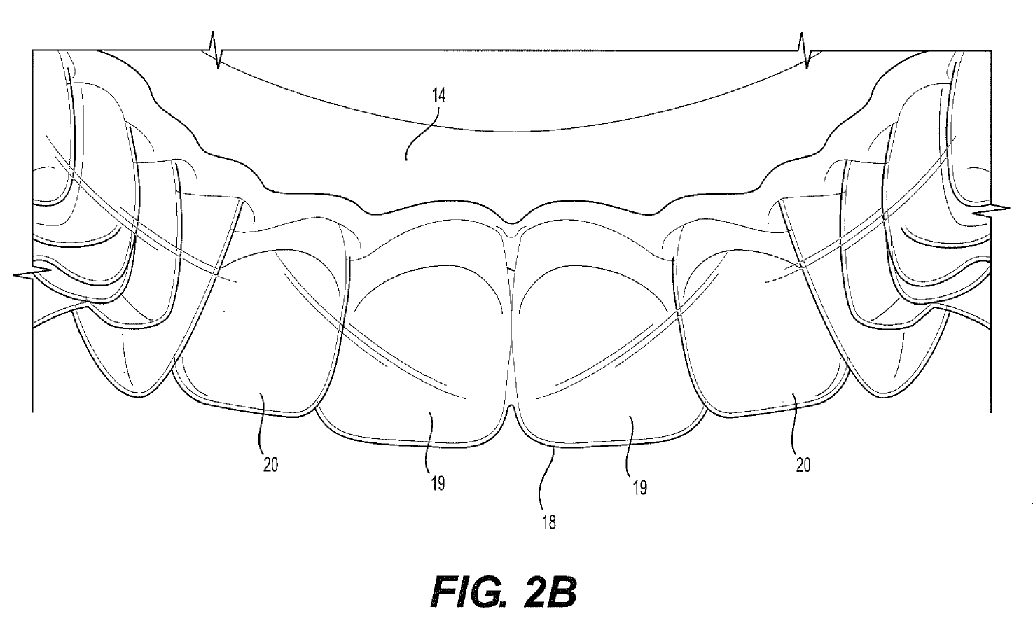

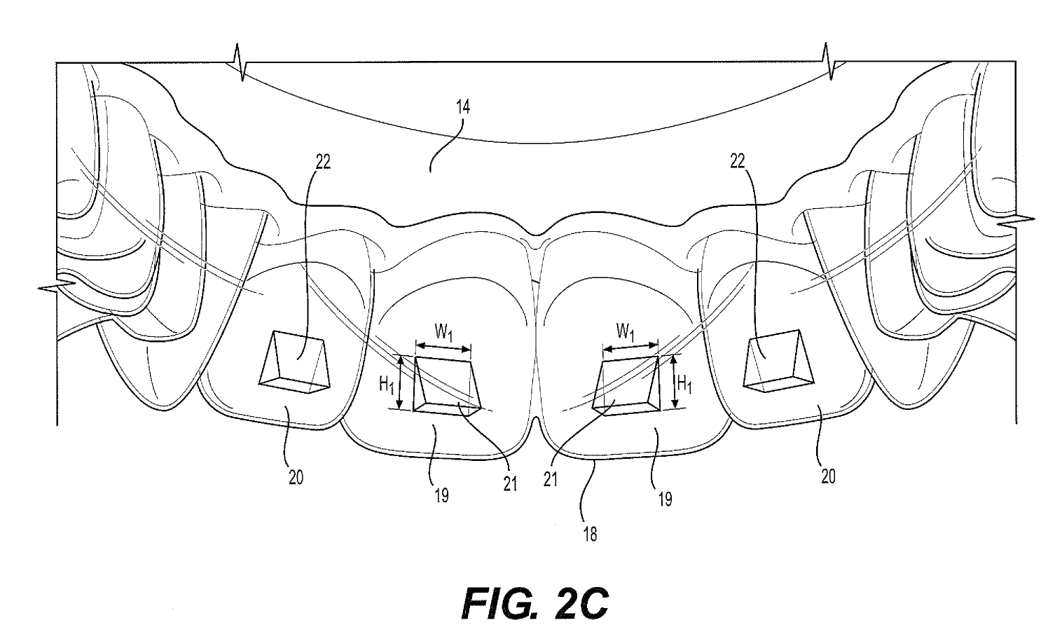

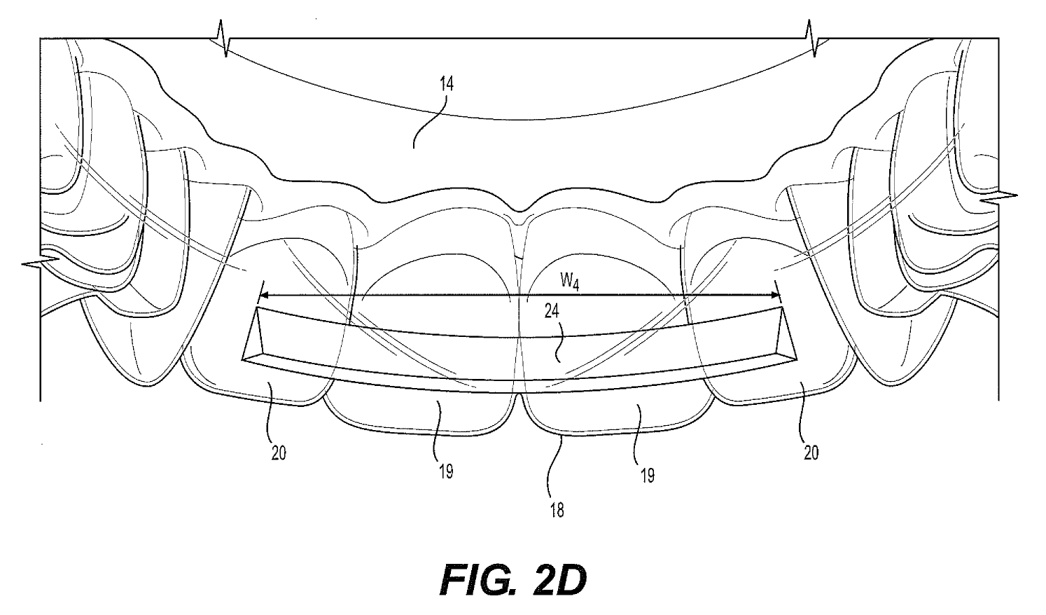

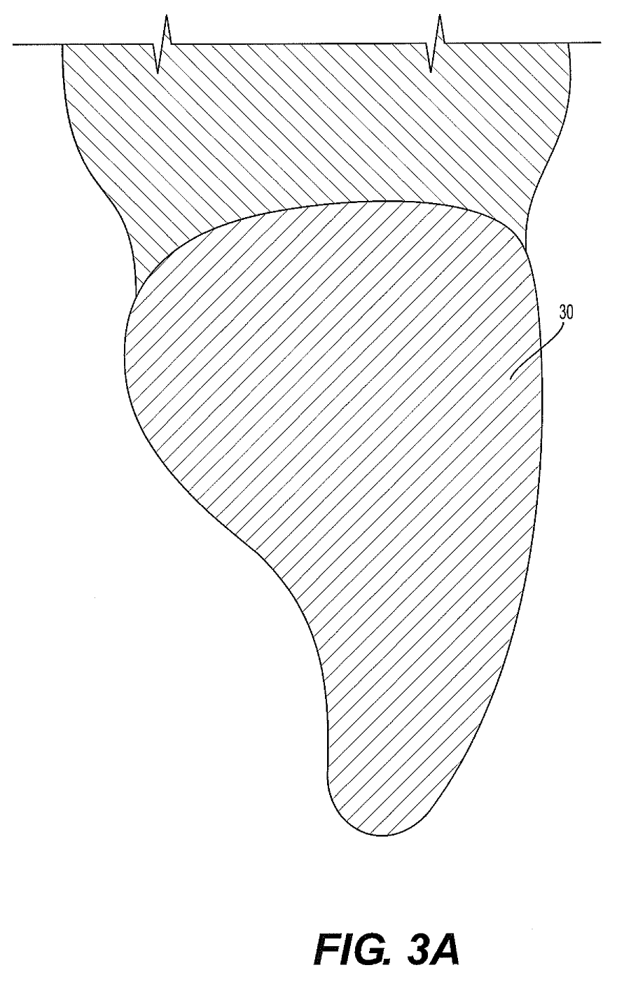

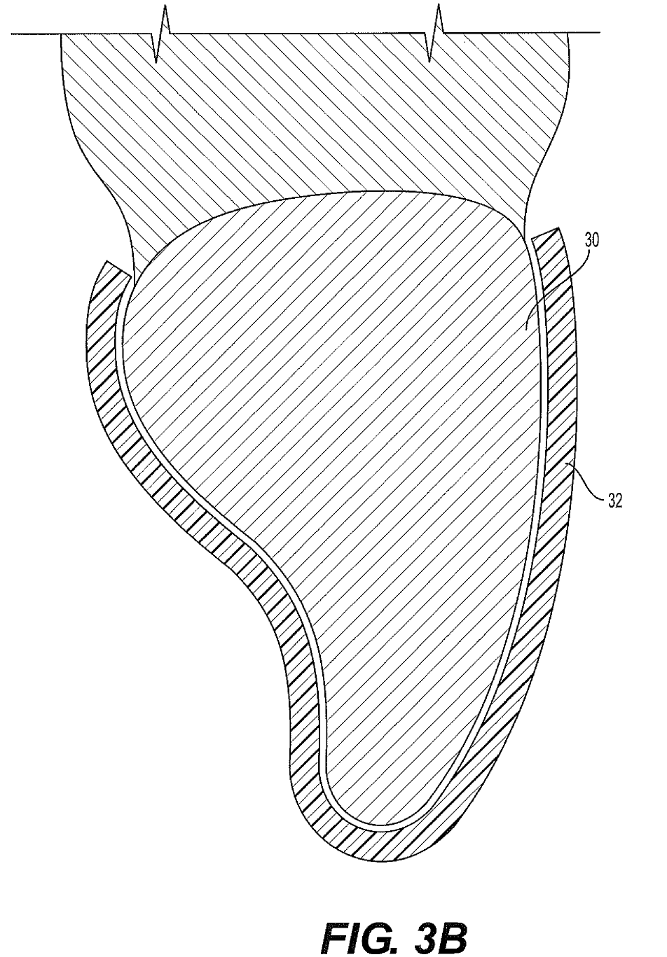

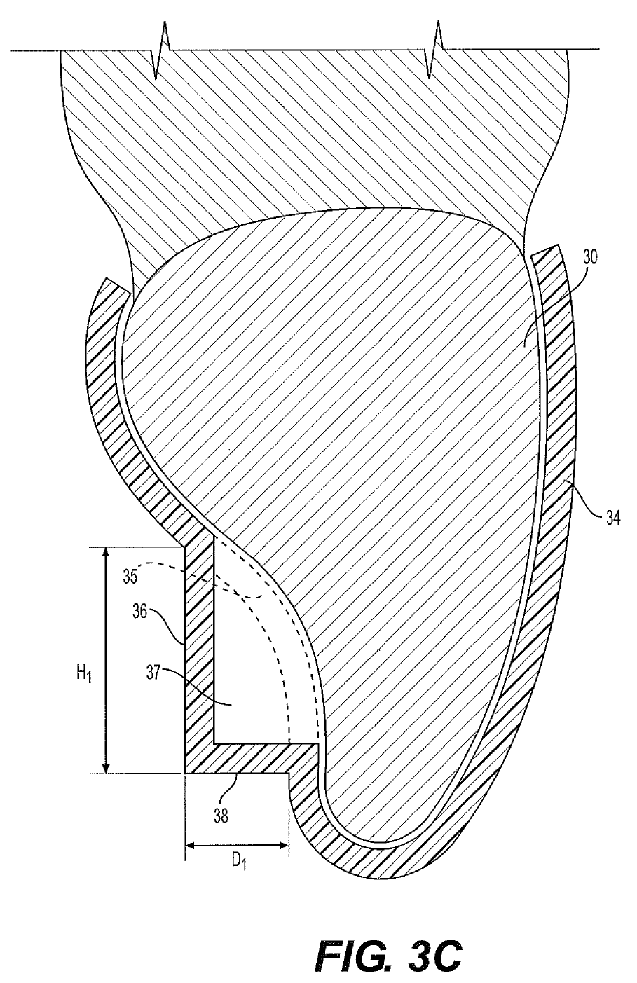

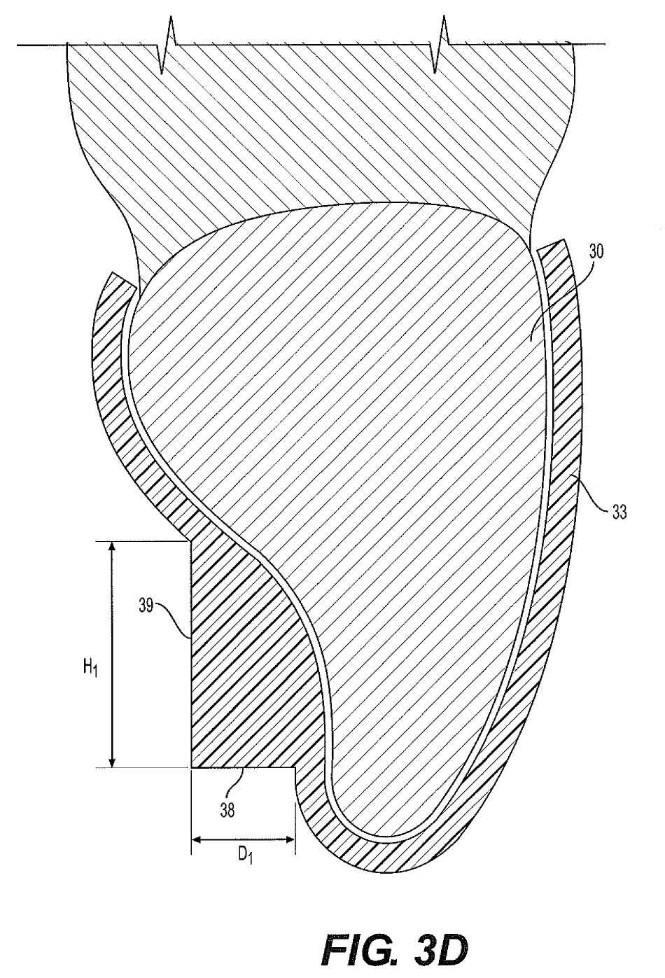

FIGS. 2A to 2D and 3A to 3D illustrate an example of the dental appliance as described herein for use on the maxillary arch of a patient.

FIG. 2A is a rear perspective view of the maxillary arch 14 which are essentially the upper teeth of a patient. The front or anterior teeth are typically considered to be the middle incisors 15 and outside incisors 16.

FIG. 2B is a rear perspective view of the maxillary arch 14 with a polymeric shell 18 covering the teeth. The specific portions of the shell 14 cover each individual tooth. As shown, and referring back also to FIG. 2A, it is apparent that the shell portions 19 define cavities that are configured around the middle incisors 15, and the portions 20 are configured around the outside incisors 16. This polymeric shell 18 is representative of a typical retainer or dental aligner appliance.

FIG. 2C is a rear perspective view of the same maxillary arch 14. In this figure, the polymeric shell 18 covers and envelopes all of the teeth. The polymeric shell 18 includes portions 19 that cover the middle incisors 15, and sections 20 that cover the outside incisors 16. The bite ramps 21 and 22 extend outwardly in the backwards direction from the incisor 15 and 16 teeth respectively. In this FIG. 2C, the bite ramps extend backwardly from the incisor portions 19 and 20 only. Fewer or more bite ramps may be incorporated into the shell 18, for instance over the canines or other teeth more toward the back or posterior portion of the maxillary arch 14. The display of these four bite ramps 21 and 22 is just one example of where a dental professional may deem appropriate for incorporation of a bite ramp. The height H1 and width W1 of the bite ramps are variable depending on the size and physiology of a patient's teeth and bite as determined by a dental professional. The specific size and range of sizes, in height and width and depth, of a bite ramp like bite ramps 21 and 22 are noted earlier herein.

FIG. 2D shows a polymeric shell 18 mounted onto the teeth of the maxillary arch 14. The shell 18 includes the portions 19 and 20 that enclose the middle incisors and outside incisors respectively. Extending outwardly and backwardly from the portions 19 and 20 of the shell 18 is a bite ramp 24 in the form of a ridge that, in this example, extends backwardly from all four incisors 19 and 20. This single ridge bite ramp 24 has a width W4. The width of the bite ramp is sized as discussed earlier herein by a dental professional according to the specific needs of a given patient. The ridge 24 is shown here in FIG. 2D as spanning four anterior teeth 15 and 16, but the ridge may optionally span two or three teeth and more than four teeth.

FIG. 3A is a side cross-sectional view of an example of a maxillary incisor tooth 30 as found on a maxillary arch. This incisor 30 would be similar to one of the incisors shown in FIG. 2C. The incisor 30 will be oriented in this downward direction when a patient is sitting or standing or whose head/maxillary arch is otherwise in the upright position.

FIG. 3B is a side cross-sectional view of the same incisor tooth 30 shown in FIG. 3A with a conventional dental appliance around it formed of a polymeric sheet 32. The polymeric sheet 32 is conventional in that it receives and generally surrounds the incisor 30 (and additional teeth of a patient—not shown specifically but similar to the teeth 10 sheet 12 combination in FIG. 1).

FIG. 3C is a side cross-sectional view of the same incisor tooth 30 shown in FIGS. 3A and 3B with a dental appliance around it formed of a polymeric shell 34 and also having a bite ramp 36 extending outwardly from the tooth in the backward direction. FIG. 3C shows the broken lines 35 where the regular dental appliance would have been. The bite ramp 36 defines a hollow space 37 between the bite ramp and the tooth 30 In alternative examples, this hollow space 37 may be solid and formed of the same material as the bite ramp 36. The bite ramp 36 has a height H1 and a depth D1 as shown. As explained earlier, the height H1 and the depth Dl may vary according to the discretion of the dental professional according to the specific needs of the patient.

FIG. 3D is a cross-section of the maxillary incisor 30 with a modified polymeric shell 33 that includes a bite ramp 39 that is a solid plastic backward extension. The height H1 and the depth D1 are the same as the bite ramp 36 in FIG. 3C, but that bite ramp 36 is hollow as compared to the solid plastic bite ramp 39.

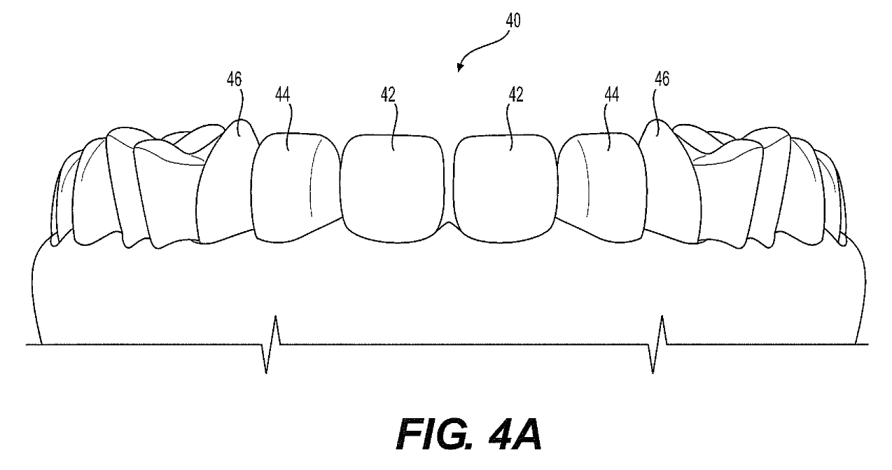

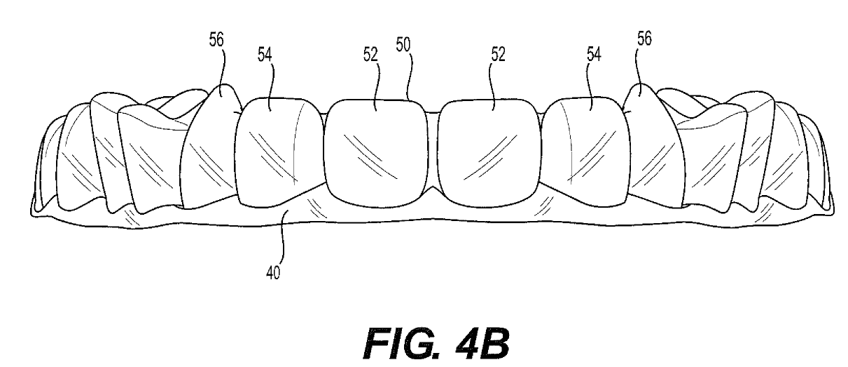

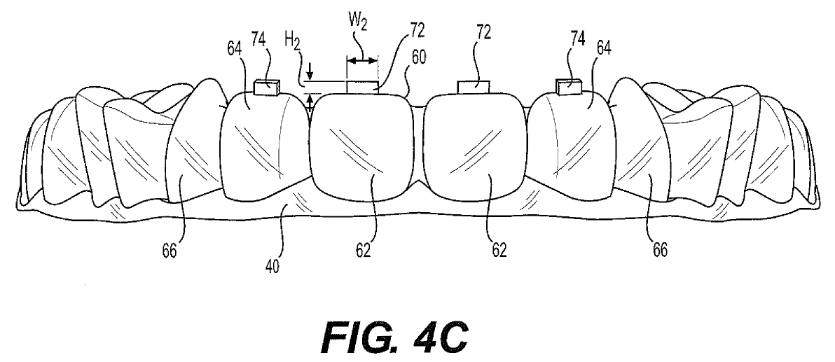

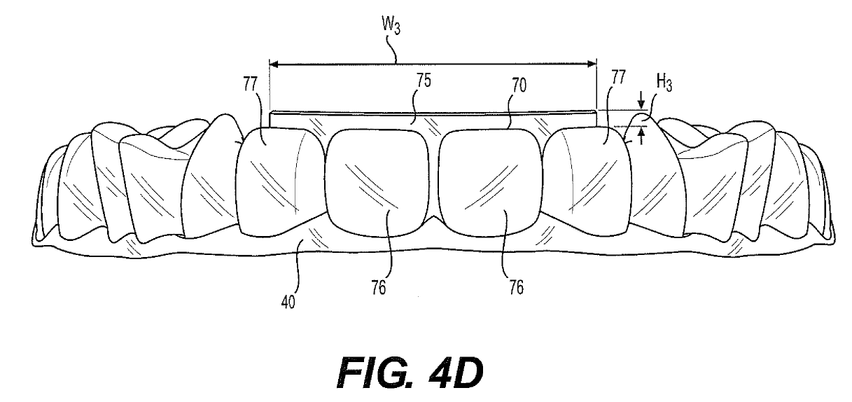

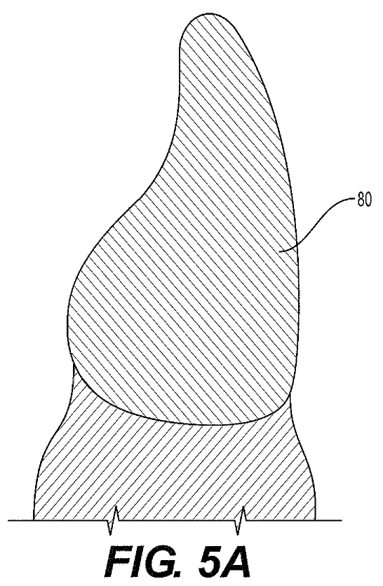

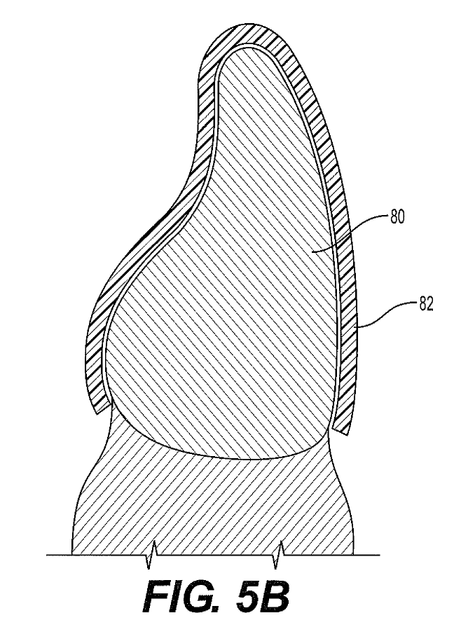

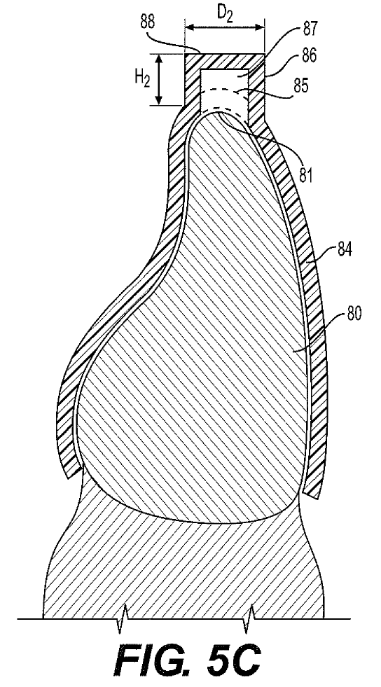

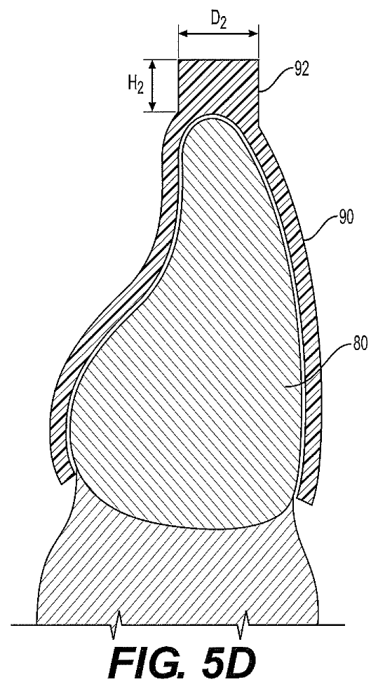

FIGS. 4A to 4D and 5A to 5D illustrate an example of the dental appliance as described herein for use on the mandibular arch of a patient.

FIG. 4A is a front view of the mandibular arch 40 which are essentially the lower teeth of a patient. The front or anterior teeth are typically considered to be the middle incisors 42, outside incisors 44 and the canines 46.

FIG. 4B is a front view of the mandibular arch 40 with a polymeric shell 50 covering the teeth. The specific portions of the shell 50 cover each individual tooth. As shown, and referring back also to FIG. 4A, it is apparent that the shell portions 52 define cavities that are configured around the middle incisors 42, the portions 54 are configured around the outside incisors 44 and the portions 56 are configured around the canines 46. This polymeric shell 50 is representative of a typical retainer or dental aligner appliance.

FIG. 4C is a front view of the same mandibular arch 40. In this figure, the polymeric shell 60 covers and envelopes all of the teeth. The polymeric shell 60 includes portions 62 that cover the middle incisors 42, sections 64 that cover the outside incisors 44, and sections 66 that cover the canines 46. The difference between the polymeric shell 60 and the previous polymeric shell 50 is the presence of projections 72 and 74. The projections 72 and 74 extend upwardly from the occlusal surface of the incisor teeth 42 and 44 and corresponding shell portions 62 and 64. In this FIG. 4C, the projections 72 and 74 extend upwardly only from the anterior incisor portions 62 and 64. Fewer or more projections may be incorporated into the shell 60, for instance over the canines 56 or other teeth more toward the back or posterior portion of the mandibular arch 40. The display of these four projections 72 and 74 is just one example of where a dental professional may deem appropriate for incorporation of a projection. The height H2 and width W2 of the projections are variable depending on the size and physiology of a patient's teeth and bite as determined by a dental professional. The specific size and range of sizes, in height and width and depth, of a projection like projections 72 and 74 are noted earlier herein.

FIG. 4D shows a polymeric shell 70 mounted onto the teeth of the mandibular arch 40. The shell includes the portions 76 and 77 that enclose the middle incisors and outside incisors respectively. Extending upwardly from the occlusal ridge of the portions 76 and 77 of the shell 70 is a projection 75 in the form of a ridge that, in this example, extends upwardly from all four incisors 76 and 77. This single ridge projection 75 has a height H3 and a width W3. The height of the projection 75 and the width of the projection are sized as discussed earlier herein by a dental professional according to the specific needs of a given patient. The ridge 75 is shown here in FIG. 4D as spanning four anterior teeth 76 and 77, but the ridge may optionally span two or three teeth and more than four teeth.

FIG. 5A is a cross-sectional view of a mandibular incisor 80. The incisor 80 is used as an example here, but of course any mandibular tooth could have been used here to demonstrate and illustrate the projection shown in FIG. 5C. FIG. 5B shows a side cross-sectional view of the same incisor tooth 80 shown in FIG. 5A with a conventional dental appliance around it formed of a polymeric sheet 82. The polymeric sheet 82 is conventional in that it receives and generally surrounds the incisor 80 (and additional teeth of a patient—not shown specifically but similar to the teeth 10 sheet 12 combination in FIG. 1).

FIG. 5C shows the mandibular incisor 80 with polymeric shell 84 wrapped around it. The polymeric shell 84 has a protuberance 86 that is an intentional plastic protuberance extending upwardly from the mandibular polymeric shell proximate an occlusal surface 81 of the incisor 80. The protuberance 86 in this example defines a hollow space 87 inside of it. The projection 86 further includes a top surface 88 that in this example is a flat surface. The projection has a height H2 and a depth D2. As discussed earlier herein, the height and depth of the protuberance (and shape of the top of the protuberance) may be adjusted according to a patient's needs in the discretion of the dental professional. Also shown in broken lines 85 is the perimeter of a regular polymeric shell covering the incisor 80 as shown for example in FIG. 5B.

FIG. 5D is a cross-section of the mandibular incisor 80 with a modified polymeric shell 90 that includes a protuberance 92 that is a solid plastic upward extension. The height H2 and the depth D2 are the same as the protrusion 86 in FIG. 5C, but that protrusion 86 is hollow as compared to the solid plastic protuberance 92.

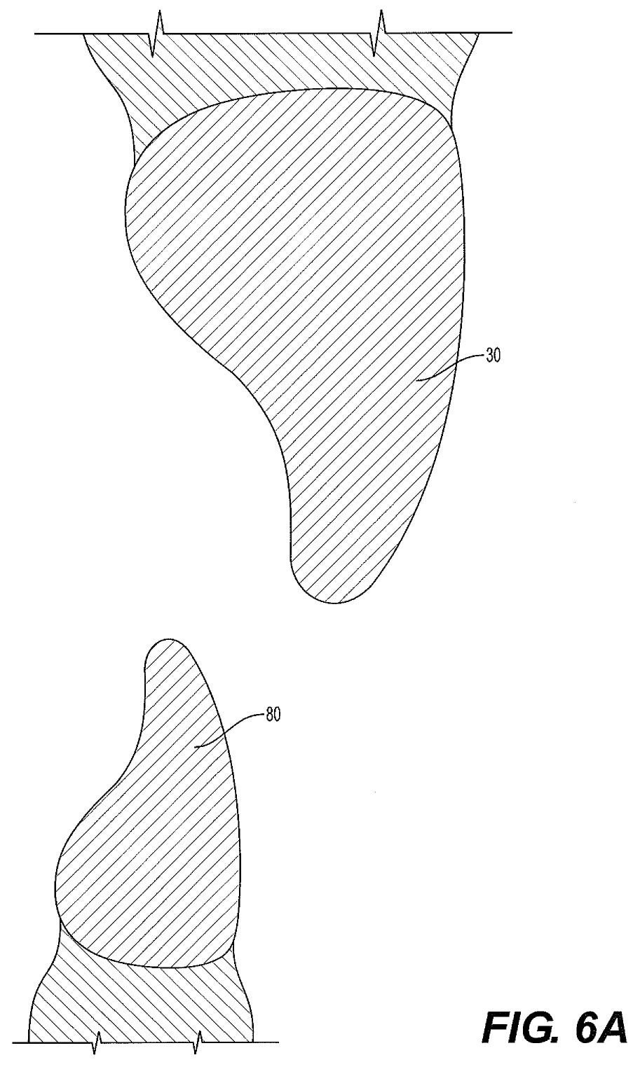

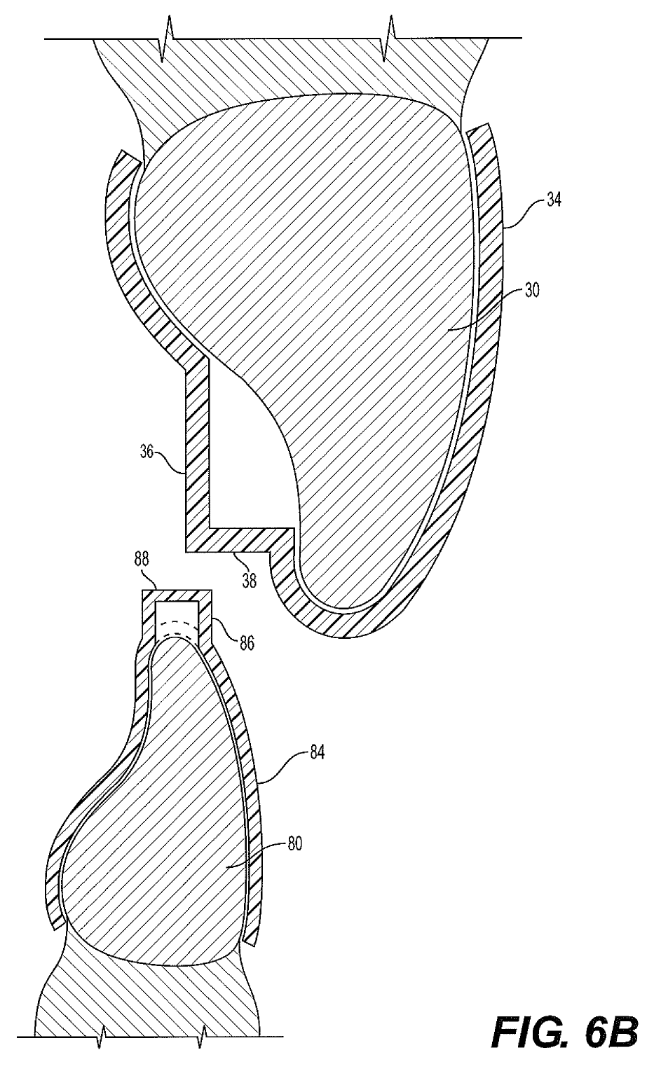

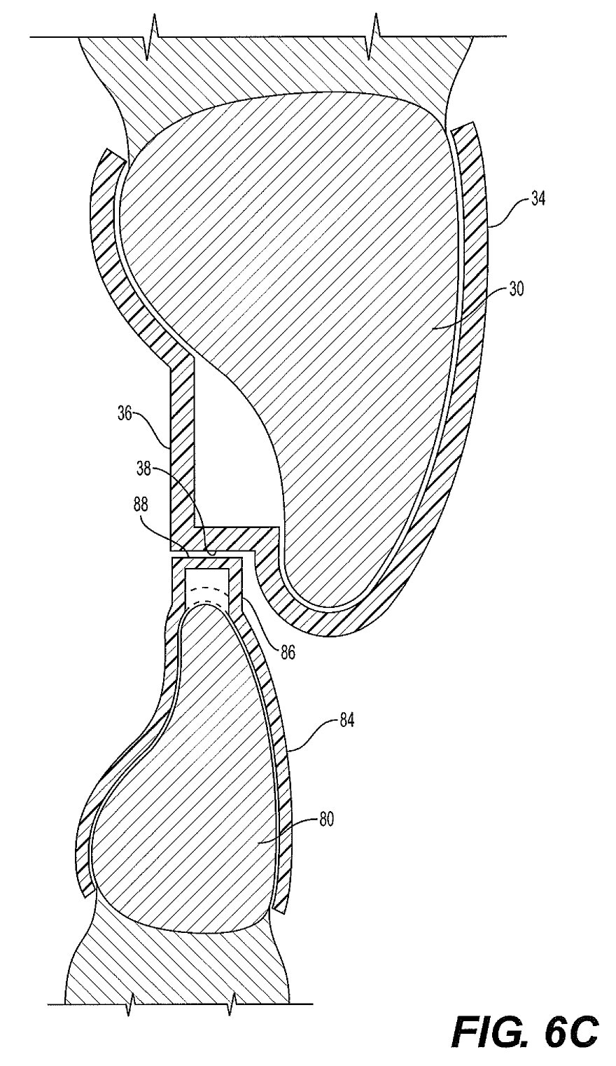

FIG. 6A is a side cross-sectional view of a mandibular incisor 80 and a maxillary incisor 30 as they might be oriented in a patient's mouth with the mouth open.

FIG. 6B is a side cross-sectional view of the respective incisors 30 and 80 with each having a polymeric shell 34 and 84 mounted around it respectively. The mandibular incisor 80 is inside the polymeric shell 84 as shown in FIG. 5C having a projection extending upwardly therefrom. The maxillary incisor 30 has a polymeric shell 34 positioned around it as shown also in FIG. 3C with a bite ramp 36 extending backwardly therefrom. In this FIG. 6B, the patient's mouth is still in an open position with space between the top surface 88 of the projection and the bottom surface 38 of the bite ramp.

FIG. 6C is a side cross-sectional view of the same incisors 30 and 80 with the same polymeric shells 34 and 84 respectively positioned around them. In this figure, however, the patient's mouth is in more of a closed position such that the projection 86 top surface 88 is in contact with the bite ramp 36 bottom surface 38. Therapeutically, the protuberance 86 and bite ramp 36 work together to prevent the patient from completely closing their mouth, thereby reducing the effects of TMD in the patient. As can be clearly seen and understood, the height of the respective projection 86 and the bite ramp 36 can be preselected by a dental professional so that the bite of the patient is engineered to be restricted as needed for that particular patient. Importantly, however, the polymeric shells 34 and 84 generally can still be worn by the patient for the aligner purposes of those shells otherwise.

Other embodiments of the present invention will be apparent to those skilled in the art from consideration of the specification. It is intended that the specification and figures be considered as exemplary only, with a true scope and spirit of the invention being indicated by the claims.

That which is claimed is:

1. A dental appliance for concurrent use as a teeth aligner and a tool for reducing temporomandibular dysfunction, the appliance comprising:
a pair of polymeric shells having a teeth-receiving cavity that defines a first side thereof,
wherein the pair of polymeric shells are comprised of a thin layer of elastomeric polymer adapted to fit over the maxillary and mandibular teeth of a patient respectively,
further wherein the polymeric shells have an anterior portion that corresponds to the anterior maxillary or mandibular teeth that are adapted to be received therein,
a projection on the mandibular polymeric shell, wherein the projection is an intentional plastic protuberance extending upwardly from the mandibular polymeric shell proximate an occlusal surface of where the anterior mandibular teeth would be received in the cavity, and
a bite ramp on the maxillary polymeric shell, wherein the bite ramp is an intentional plastic protuberance on the opposite side of the maxillary polymeric shell from the cavity and proximate the location where the back of the anterior maxillary teeth would be received in the cavity,
wherein the projection and the bite ramp are located so that they will contact each other when a patient is wearing the appliance and they bite their teeth.

2. A dental appliance as described in claim 1,
further comprising a plurality of projections from the mandibular plastic shell.

3. A dental appliance as described in claim 1,
further comprising a plurality of bite ramps on the maxillary polymeric shell.

4. A dental appliance as described in claim 1,
wherein the projection is molded into the polymeric shell.

5. A dental appliance as described in claim 1,
wherein the projection is affixed to the outside of the polymeric shell.

6. A dental appliance as described in claim 2,
wherein the plurality of projections comprises four projections that are located proximate the top of the mandibular polymeric shell where the cavity is adapted to receive the mandibular incisor teeth of a patient.

7. A dental appliance as described in claim 3,
wherein the plurality of bite ramps comprises four bite ramps that are located proximate the back of the maxillary polymeric shell where the cavity is adapted to receive the maxillary incisor teeth of a patient.

8. A dental appliance as described in claim 6,
further comprising a plurality of bite ramps on the maxillary polymeric shell,
wherein the plurality of bite ramps comprises four bite ramps that are located proximate the back of the maxillary polymeric shell where the cavity is adapted to receive the maxillary incisor teeth of a patient.

9. A dental appliance as described in claim 1,
wherein the projection is positioned as a single ridge along the top of the mandibular polymeric shell on a second side of the polymeric shell opposite the first side of the polymeric shell.

10. A dental appliance for concurrent use as a teeth aligner and a tool for reducing temporomandibular dysfunction, the appliance comprising:
a pair of polymeric shells having a teeth-receiving cavity that makes up a first side thereof,
wherein the pair of polymeric shells are comprised of a thin layer of elastomeric polymer adapted to fit over the maxillary and mandibular teeth of a patient respectively,
further wherein the polymeric shells have an anterior portion that corresponds to the anterior maxillary or mandibular teeth that are adapted to be received therein,
a projection on the mandibular polymeric shell, wherein the projection is an intentional plastic protuberance on the opposite side of the mandibular polymeric shell from the cavity and proximate an occlusal surface where the top of the anterior mandibular teeth would be received in the cavity.

11. A set of dental appliances for concurrent use as a teeth aligner and a tool for reducing temporomandibular dysfunction, the set of appliances comprising:
a first pair of polymeric shells having a teeth-receiving cavity that makes up a first side thereof,
wherein the pair of polymeric shells are comprised of a thin layer of elastomeric polymer adapted to fit over the maxillary and mandibular teeth of a patient respectively,
further wherein the polymeric shells have an anterior portion that corresponds to the anterior maxillary or mandibular teeth that are adapted to be received therein,
a projection on the mandibular polymeric shell, wherein the projection is an intentional plastic protuberance on the opposite side of the mandibular polymeric shell from the cavity and proximate an occlusal surface where the top of the anterior mandibular teeth would be received in the cavity, and
a bite ramp on the maxillary polymeric shell, wherein the bite ramp is an intentional plastic protuberance on the opposite side of the maxillary polymeric shell from the cavity and proximate the location where the back of the anterior maxillary teeth would be received in the cavity,
wherein the projection and the bite ramp are located so that they will contact each other when a patient is wearing the appliance and they bite their teeth,
and a second pair of polymeric shells having a teeth-receiving cavity that makes up a first side thereof, wherein the polymeric shells have an anterior portion that corresponds to the anterior maxillary or mandibular teeth that are adapted to be received therein,
wherein the second pair of polymeric shells do not comprise projections or bite ramps.
